(19) United States
(12) Patent Application Publication
(10) Pub. No.: US 2016/0381244 A1
(43) Pub. Date: Dec. 29, 2016

(54) IMAGE FORMING APPARATUS, IMAGE FORMING METHOD AND NON-TRANSITORY COMPUTER READABLE RECORDING MEDIUM

(71) Applicants: KABUSHIKI KAISHA TOSHIBA, Tokyo (JP); TOSHIBA TEC KABUSHIKI KAISHA, Tokyo (JP)

(72) Inventor: Koichi Shimoda, Mishima Shizuoka (JP)

(21) Appl. No.: 15/262,199

(22) Filed: Sep. 12, 2016

Related U.S. Application Data
(63) Continuation of application No. 14/684,553, filed on Apr. 13, 2015.

(51) Int. Cl. H04N 1/32; H04N 1/44; H04N 1/21; H04N 1/00

(52) U.S. Cl. CPC H04N 1/32267; H04N 1/00912; H04N 1/00846; H04N 1/4493; H04N 1/2104; H04N 2201/0094; H04N 2201/218; H04N 2201/3271; H04N 2201/3212

(57) ABSTRACT

Certain embodiments provide an image forming apparatus including: a scanner scanning an original document; a network interface receiving a print request; a print unit printing out scan data from the scanner, and print spool data from the network interface; and a controller controlling a storage device to store a plurality of job files including a copy job for printing the scan data, a print job for printing the print spool data, and a scan job for transmitting the scan data to the outside, to set whether to overwrite data for the job files when any one of the copy job, the print job, and the scan job is performed, and to embed confidential document stamp data in a sheet printed out by the copy job or the print job, and an image file generated by the scanner job when the data overwrite is selected.

### CROSS-REFERENCE TO RELATED APPLICATIONS

This application is a Continuation of application Ser. No. 14/684,553 filed on Apr. 13, 2015, the entire contents of which are incorporated herein by reference.

### FIELD

Embodiments described herein relate generally to an image forming apparatus, an image forming method and a non-transitory computer readable recording medium.

### BACKGROUND

An image forming apparatus writes an image data file for a job in a storage device such as a hard disk drive (HDD), a solid state device (SSD), or the like temporarily. The image forming apparatus deletes the file after the job is completed.

After the file is deleted, the image forming apparatus overwrites image data with pattern data such as “0000” and “1111”. The “overwrite” (or data overwrite) implies that data used is overwritten and completely erased from a storage device. The “data used” implies data after a job is completed.

The image forming apparatus may have an overwrite function of overwriting data in a HDD and a SSD and a security function of precluding data recovery.

In the related art, the image forming apparatus has a function of enabling or disabling the data overwrite function. When the data overwrite function is enabled, the image forming apparatus overwrites data used for the entirety of jobs in the storage device.

For example, the image forming apparatus overwrites each image data file three times without exception.

The data overwrite function is effective from the aspect of security.

However, when the data overwrite function is enabled, an increase in the number of data write cycles decreases the performance of a multi-function function of the image forming apparatus.

The number of data write cycles during the enablement of the data overwrite function is greater than that when the data overwrite function is disenabled. Accordingly, the life of the storage device is considerably decreased.

A HDD and a SDD have a finite number of write cycles. For example, the writing of data in a HDD and a SDD from several thousand times to several hundreds of thousand times may cause a danger of data corruption in the HDD and the SDD.

An increase in write capacity causes a decrease in a guaranteed number of write cycles of the storage device. The image forming apparatus decreases the life of the storage device.

### DESCRIPTION OF THE DRAWINGS

FIG. 1 is a configuration view of an image forming apparatus;

FIG. 2 is a block diagram of a control system including an operation panel and an affixation unit;

FIG. 3 is a flowchart illustrating a confidential document stamp data affixation process;

FIG. 4 illustrates an example of an operation selection display for selecting whether a data overwrite process is required to be performed;

FIG. 5 illustrates an example of setting information;

FIG. 6 is a flowchart illustrating the confidential document stamp data affixation process for a print job from the outside; and

FIG. 7 is a flowchart illustrating a print job process.

### DETAILED DESCRIPTION

Certain embodiments provide an image forming apparatus including: a scanner configured to scan an original document; a network interface configured to receive a print request; a print unit configured to print out scan data from the scanner, and print spool data from the network interface; and a controller configured to control a storage device to store a plurality of job files including a copy job for printing the scan data, a print job for printing the print spool data, and a scan job for transmitting the scan data to the outside, to set whether to overwrite data for the job files in the storage device when any one of the copy job, the print job, and the scan job is performed, and to embed confidential document stamp data in a sheet printed out by the copy job or the print job, and an image file generated by the scan job when the data overwrite is selected.

Hereinafter, an image forming apparatus, an image forming method, and a storage medium will be described in detail with reference to the accompanying drawings. The same reference signs will be assigned to the same portions in each of the drawings, and the repeated description thereof will not be given.

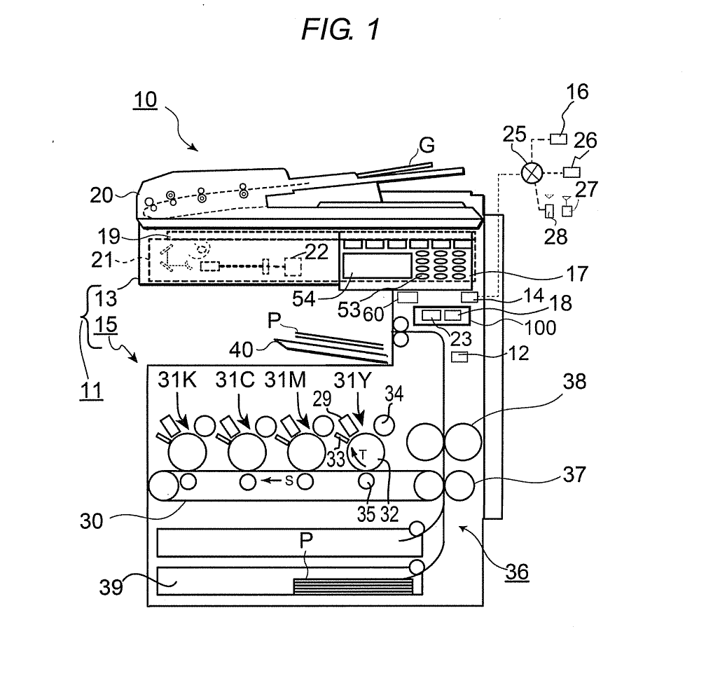

FIG. 1 is a configuration view of the image forming apparatus. The image forming apparatus of an exemplary embodiment is a multi-functional peripheral (MFP) 10.

The MFP 10 includes a main body 11 and a storage device 12.

The main body 11 includes a scanner 13 that scans an original document; a network interface 14 that receives a network print request; and a print unit 15 that prints out scan data from the scanner 13 and print spool data from the network interface 14.

The “print spool data” implies a job spooled by a client of the MFP 10.

The main body 11 performs a multi-function function. The storage device 12 of the main body 11 is a file storage configured to store a plurality of job files for a plurality of jobs.

The “plurality of jobs” implies a copy job for printing a scanner' s output, a print job for printing the print spool data, and a scan job for transmitting the scanner' s output to a remote server (installed outside of the image forming apparatus) 16.

The MFP 10 may have a facsimile transceiver 60. The plurality of jobs may include a facsimile transmission job for transmitting a scanner' s output via facsimile, and a facsimile reception job for printing image data received via facsimile.

The MFP 10 further includes: an operation panel 17; a confidential document stamp affixation unit 18; and a controller 100.

A user sets the main body 11 as to whether to overwrite job file data for the copy job and the scan job by operating the operation panel 17. In addition, the user sets the main body 11 as to whether to analyze and overwrite the print spool data for the print job (to be described later) via the operation panel 17.

The confidential document stamp affixation unit 18 embeds confidential document stamp data in a sheet P printed out by the copy job or the print job and an image file generated by the scan job, based on a selection of a data overwrite process via the operation panel 17 and an analysis result of the print spool data.

The controller 100 is a main controller of the MFP 10. The scanner 13 of the main body 11 generates light receiving signals for four colors such as the red (R) color, the green (G) color, the blue (B) color, and the black (K) color. The scanner 13 has a document feeder 20; an optical system 21; and a signal processing device 22.

The document feeder 20 transports an original document G on a glass base 19.

The optical system 21 generates image data by scanning the surface of the original document on the glass base 19.

The signal processing device 22 processes an analog light receiving signal from the scanner 13.

The main body 11 further includes an image processing unit 23.

The image processing unit 23 converts R, G, B, and K image data from the scanner 13 into Y, M, C, and K print colors.

The image processing unit 23 generates print image data based on page description language (PDL) data from the network interface 14.

The image processing unit 23 is configured to use an LSI, a central processing unit (CPU), a read only memory (ROM), and a random access memory (RAM).

The network interface 14 is a network communication unit. The network interface 14 receives print spool data from personal computers (PCs) 26 and 27 via a network 25, or transmits a scanner's output to the remote server 16.

The PC 26 is a fixed PC. The PC 27 is a wireless PC. An access point (AP) 28 is connected to the PC 27 and the network 25. A printer driver 61 is installed on each of the PCs 26 and 27, and corresponds to the MFP 10.

The print unit 15 includes: four light exposure units 29; a common belt 30; and image forming units 31Y, 31M, 31C, and 31K. The light exposure unit 29 modulates a laser beam from a semiconductor laser for a color with an image signal. The belt 30 travels endlessly in a counter-clockwise direction S.

The image forming unit 31Y for the yellow (Y) color includes: a drum 32; a charger 33; a developer 34; and a transfer unit 35.

The drum 32 is a photoconductive drum configured to rotate in a clockwise direction T. The charger 33 charges the surface of the drum 32 with electricity. The developer 34 develops an electrostatic latent image on the drum 32 using toner. The transfer unit 35 primarily transfers a toner image from the drum 32 onto the belt 30.

Each of the image forming unit 31M for the magenta (M) color, the image forming unit 31C for the cyan (C) color, and the image forming unit 31K for the black (K) color is configured similar to that of the image forming unit 31Y.

The main body 11 further has: a sheet transport mechanism 36; a secondary transfer unit 37; a fixing unit 38; and a tray 40.

The sheet transport mechanism. 36 picks up the sheet P from a sheet supply unit 39, and guides the sheet P to the print unit 15.

The secondary transfer unit 37 secondarily transfers four color toner images from the image forming units 31Y, 31M, 31C, and 31K onto the sheet P via the belt 30.

The fixing unit 38 fixes non-fixed toner images on the sheet P. The sheet transport mechanism 36 discharges a sheet having the image fixed thereon onto the tray 40.

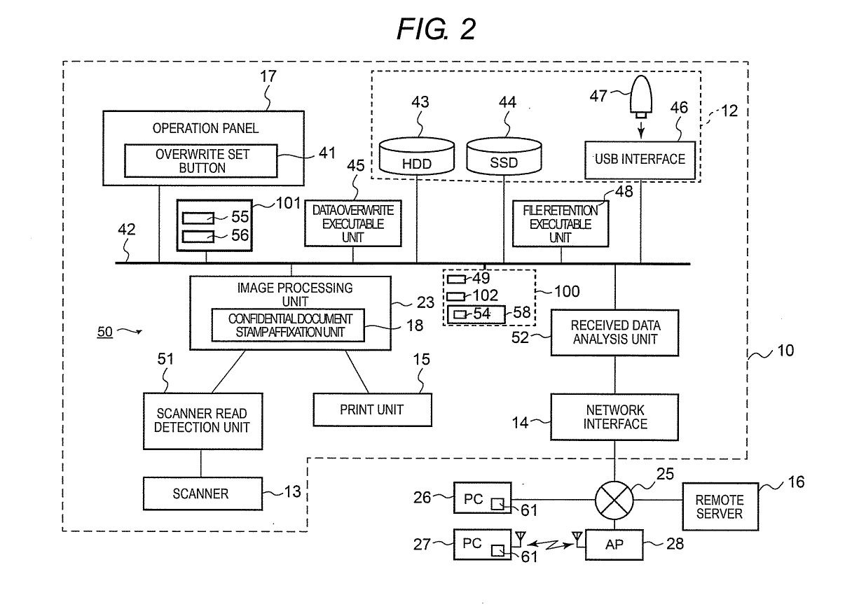

FIG. 2 is a block diagram of a control system of the MFP 10 including the operation panel 17 and the confidential document stamp affixation unit 18. The above-mentioned like reference signs indicate like elements.

The control system 50 performs the functions of the MFP 10, which correspond to job types, respectively.

The control system 50 includes the following units on a bus 42: the storage device 12; the operation panel 17; the controller 100; a page memory 101; a data overwrite executable unit 45; a file retention executable unit 48; the image processing unit 23; a scanner read detection unit (a detection unit) 51; and a received data analysis unit (a detection unit) 52.

The storage device 12 has a hard disk drive (HDD) 43 and a solid state drive (SDD) 44. The data read and write speed of the SSD 44 is higher than that of the HDD 43.

The storage device 12 may have a USB memory 47 connected thereto via a universal serial bus (USB) interface 46.

The controller 100 temporarily writes print job file data or scan job file data in the HDD 43 or the SSD 44, the print job file data or the scan job file data corresponding to an occurrence of the copy job, the print job, the scan job, or the facsimile transmission and reception job.

The controller 100 sequentially assigns numbers to the respective jobs associated with a plurality of job files by spooling the print jobs, and transmits a print data pointer for each of the jobs to the print unit 15.

The operation panel 17 has an overwrite set button 41. The overwrite setting (the data overwrite setting) implies a function of specifying whether data overwrite is required by the operation panel 17 or the properties of the printer driver on the PC 26 (refer to FIG. 2).

Before a job start command is released, the overwrite set button 41 notifies the control system 50 whether the data overwrite is required.

For example, as illustrated in FIG. 1, the operation panel 17 has a plurality of buttons 53 and a touch panel display 54. The buttons 53 are hardware buttons such as a command button, numeric keys, and a memory reference button.

The overwrite set button 41 is operated via a touch key on the touch panel display 54. Alternatively, the overwrite set button 41 is operated via any one of the plurality of buttons 53.

The controller 100 generates the copy job by a user's operation after the original document is set on the scanner 13. When the controller 100 receives a network print request from the network interface 14, the controller 100 generates a print job.

The controller 100 generates the scan job by a user' s operation after the original document is set on the scanner 13.

The controller 100 includes: a CPU 102; a ROM 49; and a RAM (memory) 58.

The ROM 49 stores an operating system (OS), an application software, and the like.

The RAM 58 stores setting information in a first storage area 54, the setting information being indicative of whether the data overwrite via the operation panel 17 is required for each job. The setting information retains a job and information indicative of whether the data overwrite process is required to be performed in a state where the job is associated with the information.

For example, a part of a job management table of the OS may be used as the setting information. The job management table is in order for the OS to monitor the jobs. The job management table includes a job name, a job creation date and time, a user name, and a job size.

The page memory 101 has a second storage area 55 and a third storage area 56.

The second storage area 55 stores print image data processed by the image processing unit 23 or the network interface 14. The third storage area 56 stores image data read by the scanner 13.

The data overwrite executable unit 45 overwrites the print job files according to the content of the setting information in the first storage area 54.

When a network print request is received, the data overwrite executable unit 45 overwrites the print job files when detecting the confidential document stamp data from the print spool data.

The file retention executable unit 48 writes the image data for the scan job from the image processing unit 23 in the storage device 12.

The image processing unit 23 has the confidential document stamp affixation unit 18.

When the data overwrite is specified via the overwrite set button 41, the confidential document stamp affixation unit 18 embeds the confidential document stamp data on the printout sheet P and in the image file retained in the remote server 16.

The specifying of the data overwrite implies that the data overwrite process is performed.

The confidential document stamp data is a visible mark on the sheet P. In addition, the confidential document stamp data is a visible mark on the display. The confidential document stamp data being visible on the display implies that the confidential document stamp data can be seen via the operation panel 17 or the like when the image file is opened by the operation panel 17 or the application software in each of the PCs 26 and 27.

The scanner read detection unit 51 is a detection unit, and detects whether the image data obtained by the scanner 13 includes the confidential document stamp data.

The received data analysis unit 52 analyzes whether the print image data from the network interface 14 includes the confidential document stamp data, and detects the confidential document stamp data.

The ROM 49 is a non-transitory computer readable recording medium configured to cause the controller 100 of the MFP 10 to perform the following processes.

Commanding the start of any one of the plurality of jobs including the copy job, the print job, and the scan job;

Setting whether to overwrite the job files for the jobs stored in the storage device 12; and

Embedding the confidential document stamp data in the sheet printed out by the copy job and the print job and the image file generated by the scan job, based on the selection of the data overwrite process.

Subsequently, the operation of the MFP 10 will be described.

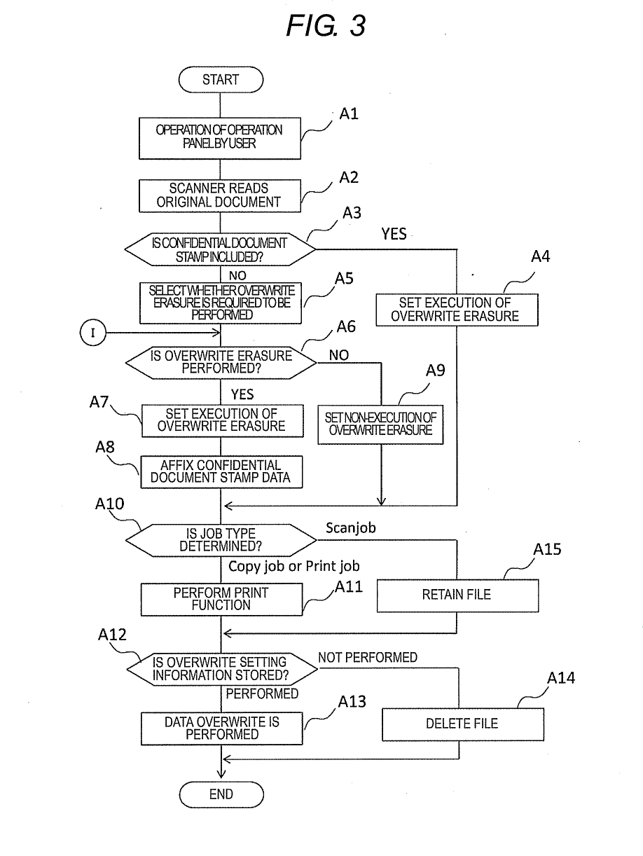

FIG. 3 is a flowchart illustrating the confidential document stamp data affixation process performed by the MFP 10.

The user sets the original document G on the document feeder 20 before the copy job or the scan job is performed.

In Act A1, the controller 100 receives the specifying of the copy job or the scan job in the operation panel 17. The MFP 10 starts a job in response to a user's operation indicative of the starting of the job.

In Act A2, the scanner 13 and the image processing unit 23 read the original document. The MFP 10 downloads the image data in the HDD 43 or the SSD 44.

Subsequently, in Act A3, the scanner read detection unit 51 determines whether the confidential document stamp data is included in the image data of the original document read by the scanner 13 (the affixing of the confidential document stamp data will be described later).

When the scanner read detection unit 51 detects the confidential document stamp data (YES in Act A3), in Act A4, the scanner read detection unit 51 stores setting information for specifying data overwrite erasure in the first storage area 54.

When the scanner read detection unit 51 does not detect the confidential document stamp data (NO in Act A3), in Act A5, the controller 100 selects whether the data overwrite process is required to be performed.

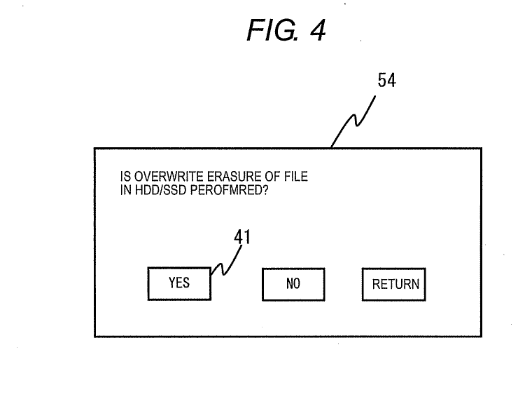

FIG. 4 illustrates an example of a display of an operation selection screen through which the user selects whether a data overwrite process is required to be performed. The above-mentioned like reference signs indicate like elements. The operation panel 17 displays the overwrite set button 41. The user instructs whether to perform the data overwrite process via the operation panel 17.

In Act A5 illustrated in FIG. 3, the controller 100 waits for a reply message from the operation panel 17. The controller 100 starts to wait for the reply message when the overwrite set button 41 is displayed.

When the controller 100 receives a signal indicative of pressing down the overwrite set button 41 from the operation panel 17, the controller 100 determines that the overwriting of the job file data is specified.

When it is determined that the data overwrite is specified in Act A6, the controller 100 stores setting information for specifying the data overwrite in the first storage area 54 via a YES route in Act A7.

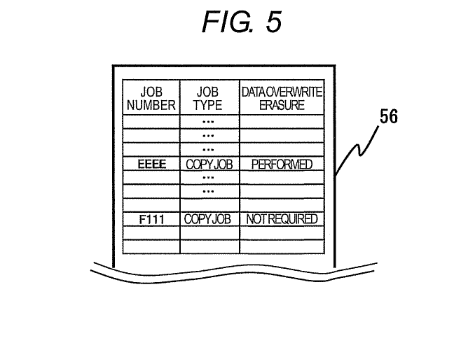

Here, FIG. 5 is a table illustrating an example of setting information. The above-mentioned like reference signs indicate like elements. The controller 100 stores a setting as to whether data for each of the copy job and the scan job is overwritten.

In Act A8 illustrated in FIG. 3, the confidential document stamp affixation unit 18 of the image processing unit 23 affixes the confidential document data in a blank space of the image data of the original document.

In Act A7, the OS may notify the image processing unit 23 of the setting information for specifying the data overwrite.

In contrast, when the controller 100 receives an electric signal indicative of non-selection of the data overwrite from the operation panel 17 in Act A6, the controller 100 stores a setting through which the data overwrite process is not performed. Alternatively, when time is up, the controller 100 may determine that the data overwrite is not specified.

When the data overwrite is not specified in Act A6, the controller 100 stores the setting information in the first storage area 54 via a NO route in Act A9, the setting information indicating that the data overwrite process is not performed.

Subsequent to Act A9 (Act A4 or Act A8), the controller 100 determines a job type in Act A10. When the controller 100 determines the job type as the copy job in Act A10, the print unit 15 performs a print function via a route named “copy job” or “print job” in Act A11.

In the copy job or the print job, the confidential document stamp data is embedded in a printout sheet, and the sheet having the confidential document stamp affixed thereto is obtained.

When the controller 100 performs the copy job, the HDD 43 or the SDD 44 still retains the image data file used.

After the printout is completed (Act A11), the controller 100 proceeds to Act A12. In Act A12, the controller 100 determines whether the first storage area 54 stores the setting information for specifying the data overwrite.

In Act A12, the controller 100 may determine that the first storage area 54 stores the setting information for specifying the data overwrite.

When the setting information is stored, the data overwrite executable unit 45 overwrites the image data used via an “execution” route in Act A13.

For example, the data overwrite executable unit 45 overwrites the image data with pattern data such as “0000” and “1111”.

In Act A12, the controller 100 may determine that the first storage area 54 does not store the setting information for specifying the data overwrite.

When the setting information is not stored, the controller 100 or the data overwriting executable unit 45 simply deletes only the image file used via a “non-execution” route (Act A14). Thereafter, the data overwrite executable unit 45 deletes the copy job from a job list.

As such, it is possible to set the MFP 10 as to whether the copy job data is overwritten, in response to a user's operation.

The MFP 10 also performs substantially the same operation for the scan job as that for the copy job. When the user specifies the data overwrite via the operation panel 17, the MFP 10 embeds the confidential document stamp data in a job file for the scan job, and outputs the job file.

In Act A10, the job type is determined as the scan job. In Act A15, the file retention executable unit 48 retains a scan image as an image file in the storage device 12 or the remote server 16.

When the controller 100 performs the scan job, the HDD 43 or the SSD 44 still retains the image data file used.

The controller 100 performs the data overwrite process similar to that in the copy job.

In Act A12, the controller 100 may determine that the first storage area 54 stores the setting information for specifying the data overwrite. When the setting information is stored, the controller 100 proceeds to Act A13 via an “execution” route.

In Act 13, the data overwrite executable unit 45 overwrites the image data used. For example, the data overwrite executable unit 45 overwrites the image data with pattern data such as “0000” and “1111”.

In Act A12, the first storage area 54 may not store the setting information for specifying the data overwrite. When the setting information is not stored, the controller 100 or the data overwrite executable unit 45 simply deletes only the image file used via a “non-execution” route. Thereafter, the controller 100 deletes the scan job from the job list.

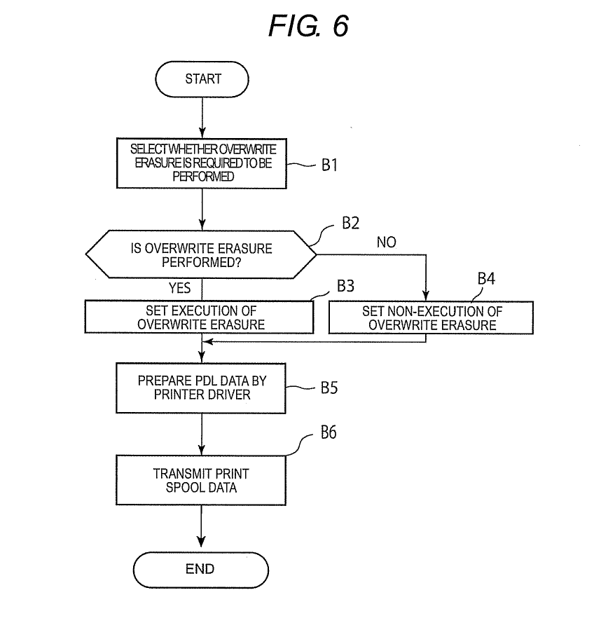

FIG. 6 is a flowchart illustrating a confidential document stamp data affixation process performed by the PC 26 for the print job.

Before the PC 26 transmits the print spool data to the MFP 10, the PC 26 performs Acts B1 and B2.

In Act B1, the printer driver 61 of the PC 26 displays a graphical print set screen on a PC display. In Act B1, via communication with the print set screen, the PC 26 controls the PC display to display an operation selection dialog box for selecting whether the data overwrite process is required to be performed (substantially the same as in the example illustrated in FIG. 4).

When a user's operation of specifying the data overwrite is input to the PC 26 in subsequent Act B2, the printer driver 61 determines that the data overwrite is specified via a YES route in Act B3.

Alternatively, when a user's operation of not specifying the data overwrite is input to the PC 26 in Act B2, the printer driver 61 determines that the data overwrite is not specified via a NO route in Act B4.

In Act B5, the printer driver 61 prepares PDL data for a document. In Act B5, the printer driver 61 prepares the print job configured to include the PDL data and a header based on a print command by a user's operation.

The printer driver 61 inserts an indication of whether to specify the data overwrite into the header. The printer driver 61 registers the print job on a spooler (a program) of the PC 26.

In Act B6, the printer driver 61 generates a queue of print jobs waiting to be processed in a memory of the PC in response to a processing load of the MFP 10.

The printer driver 61 transmits the print spool data to the MFP 10.

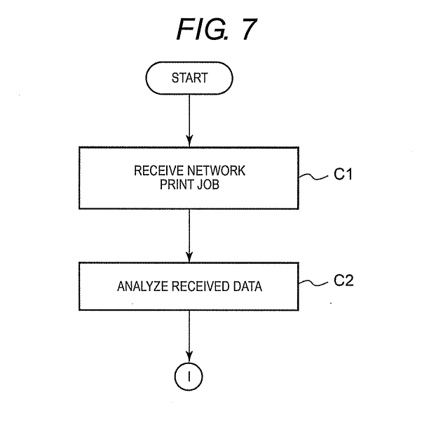

FIG. 7 is a flowchart illustrating a print job process. FIG. 7 illustrates a process of receiving the print job transmitted from the PC 26.

In Act C1, the MFP 10 receives a network print request via the network 25.

In Act C1, the MFP 10 registers the network print job on the OS. The setting information is associated with the job. The PC 26 specifies, in the setting information, whether the data overwrite is set.

In subsequent Act C2, when the network print request is received, the MFP 10 analyzes the received data.

The received data analysis unit 52 deploys the print spool data into the print image data in the page memory 101.

The MFP 10 proceeds to Act A6 following reference sign I illustrated in FIG. 3, and performs the following processes.

In Act A6, the received data analysis unit 52 analyzes whether the print image data includes data for specifying the setting of data overwrite. The analysis is performed according to print setting information included in the print spool data from the PC 26.

The following processes are the same as those in the copy job. An operation of the PC 27 is the same as that of the PC 26.

In this configuration, the data overwrite process is only performed for a necessary document, and it is possible to improve the functional performance of the MFP, or to reduce the number of write cycles to the HDD 43 or the SSD 44.

In summary, when the job such as the copy job, the scan job, or the network print job is performed, the MFP 10 receives whether the data overwrite process is performed.

When the setting of data overwrite is effective, the MFP 10 overwrites the data used after the job is performed.

Data indicative of a confidential document is embedded in a printed material output by the job such as the copy job, the scan job, or the network print job, or a retained file.

For example, when the MFP 10 re-copies the printed material, an image data file of the printed material is temporarily overwritten even when the data overwrite is not specified via the operation panel 17. In this manner, the security of the printed material improves.

In the image forming apparatus, the image forming method, and the recording medium of the exemplary embodiment, the data overwrite process is only performed for a necessary document. Accordingly, it is possible to improve the performance of the multi-function function. It is possible to reduce the number of write cycles to the HDD 43 or the SSD 44.

When the document is re-used, the MFP 10 performs the data overwrite process even though the user forgets to specify the setting of data overwrite in the MFP 10.

In the image forming apparatus, the image forming method, and the recording medium of the exemplary embodiment, the user can specify whether the data overwrite for each job is required to be performed. It is possible to specify the setting of data overwrite via the operation panel 17 when a job is performed.

It is possible to specify the setting of data overwrite by the properties of the printer driver 61 of each of the PCs 26 and 27.

When the MFP 10 downloads a file as image data, the MFP 10 can detect whether the original document G or the print spool data includes the confidential document stamp data.

When the setting of data overwrite is specified, it is possible to automatically affix the confidential document stamp data to the file that is downloaded as the image data.

When the setting of data overwrite is specified, it is possible to overwrite the data used after the job is completed.

Also, when the setting of data overwrite is not specified, and the confidential document stamp is detected, it is possible to overwrite the data used after the job is completed.

The confidential document stamp is a visible mark; however, the confidential document stamp can be a non-visible mark.

In the exemplary embodiment, the image forming apparatus may also overwrite backup file data for a print job file or a transmitted job file.

In the exemplary embodiment, the scanner 13 includes the signal processing device 22; however, the main body 11 may include the signal processing device 22. The operation panel 17 may browse a web page. The configurations illustrated in FIGS. 1 and 2 can be modified in various forms.

In the exemplary embodiment, the function of each of the confidential document stamp affixation unit 18, the data overwrite executable unit 45, the file retention executable unit 48, the scanner read detection unit 51, and the received data analysis unit 52 is performed by the RAM, the ROM, the CPU, the LSI, and a control substrate.

The computer readable recording medium causes the CPU to perform various processes, and may be a USB memory, a CD-ROM, or a DVD-ROM.

The superiority of the image forming apparatus, the image forming method, and the recording medium of the exemplary embodiment over a material product changed in this manner and embodied is not damaged.

While certain embodiments have been described, these embodiments have been presented by way of example only, and are not intended to limit the scope of the inventions. Indeed, the novel methods and systems described herein may be embodied in a variety of other forms; furthermore various omissions and substitutions and changes in the form of methods and systems described herein may be made without departing from the spirit of the inventions. The accompanying claims and their equivalents are intended to cover such forms or modifications as would fall within the scope and spirits of the inventions.

What is claimed is:

1. An image processing apparatus comprising:
a scanner configured to scan an original document;
a network interface configured to communicate with an external device;
a controller configured to:
detect whether a visible mark indicating confidential is included in scan data;
send the scan data to the external device;
delete the scan data after sending the scan data in case the visible mark is not detected; and
overwrite the scan data with pattern data after sending the scan data in case the visible mark is detected.

2. The apparatus of claim 1, further comprising:
a memory configured to store the scan data and information indicative of whether to detect the visible mark.

3. An image forming apparatus comprising:
a print unit configured to print image data;
a controller configured to:
detect whether a visible mark indicating confidential is included in the image data;
delete the image data after printing the image data in case the visible mark is not detected; and
overwrite the image data with pattern data after printing the image data in case the visible mark is detected.

4. The apparatus of claim 3, further comprising:
a scanner configured to scan an original document; and
wherein the image data is scan data.

5. The apparatus of claim 3, further comprising:
a network interface configured to receive print data from an external device; and
wherein the image data is the print data.

6. The apparatus of claim 3, further comprising:
a memory configured to store the image data and information indicative of whether to detect the visible mark.

7. A data overwriting method performed in an image forming apparatus, the method comprising:
printing image data;
detecting whether a visible mark indicating confidential is included in the image data;
deleting the image data in case the visible mark is not detected; and
overwriting the image data with pattern data in case the visible mark is detected.

8. The method of claim 7, wherein
in the printing image data,
the image data is scan data by a scanner, the scanner scanning an original document.

9. The method of claim 7, wherein
in the printing image data,
the image data is print data by a network interface,.the network interface receiving the print data from an external device.

10. The method of claim 7, wherein
the detecting is performed by referring to a memory, the memory storing the image data and information indicative of whether to detect the visible mark.
